(19) United States
(12) Patent Application Publication
(10) Pub. No.: US 2009/0026399 A1
(43) Pub. Date: Jan. 29, 2009

(54) SOLENOID VALVE

(75) Inventor: Ryo Ishibashi, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/179,644

(22) Filed: Jul. 25, 2008

(30) Foreign Application Priority Data
Jul. 25, 2007 (JP) 2007-193704

(51) Int. Cl. F16K 31/02

(52) U.S. Cl. 251/129.15

(57) ABSTRACT

A shaft is placed through an axial through hole of an opposing magnetic portion of a slidable core and applies a displacement force of a plunger to a spool. The plunger has a plunger breathing hole that axially extends through the plunger along a center axis of the plunger. The shaft has a small diameter pipe portion, which is received in the plunger breathing hole, and a large diameter pipe portion, which has an inner diameter and an outer diameter that are larger than an inner diameter of the plunger breathing hole. A plunger front chamber and a plunger rear chamber are respectively defined on a front side and a rear side of the plunger and are communicated with a solenoid front chamber through an interior of the shaft.

### CROSS REFERENCE TO RELATED APPLICATION

This application is based on and incorporates herein by reference Japanese Patent Application No. 2007-193704 filed on Jul. 25, 2007.

### BACKGROUND OF THE INVENTION

1. Field of the Invention

The present invention relates to a solenoid valve.

2. Description of Related Art

Japanese Unexamined Patent Publication No. 2005-214236 teaches a solenoid hydraulic pressure control valve as an example of a solenoid valve. In the solenoid hydraulic pressure control valve, a valve device (e.g., a spool valve) is driven to open and close oil flow passages, to switch the oil flow passages, to control pressure in the oil flow passages and to control the amount of flow in the oil flow passages.

In the solenoid hydraulic pressure control valve of Japanese Unexamined Patent Publication No. 2005-214236, the spool valve is received in a hydraulic pressure control case (a case of a hydraulic pressure controller), which forms a hydraulic circuit, and the solenoid actuator is placed at the outside of the hydraulic pressure control case. Therefore, the solenoid actuator is exposed to the external atmosphere.

Now, previously proposed solenoid hydraulic pressure control valves will be described for illustrative purpose with reference to FIGS. 4A and 4B.

The solenoid hydraulic pressure control valve shown in FIG. 4A includes a spool valve 1 and a solenoid actuator 2. The spool valve 1 has a sleeve 3 and a spool 4. The solenoid actuator 2 drives the spool valve 1.

The solenoid actuator 2 includes a coil 13, a yoke 17, a stator core 21 and a plunger 14. The coil 13 is received in the yoke 17, and the stator core 21 is placed radially inward of the coil 13. The plunger 14 axially slides in the interior of the stator core 21. An opposing magnetic portion 18b, which is axially opposed to the plunger 14, is formed in the stator core 21.

When the coil 13 is energized, the plunger 14 is magnetically attracted to the opposing magnetic portion 18b, and a displacement force of the plunger 14 is conducted to the spool 4 through a shaft 11, which is received through a through hole that extends through the opposing magnetic portion 18b.

The interior of the solenoid actuator 2 is covered with the yoke 17 and is partitioned from the outside by a seal member (e.g., an O-ring) 22. That is, leakage of the oil, which is contained in the interior of the solenoid actuator 2, to the outside is limited by the seal member 22.

The interior of the solenoid actuator 2 is axially partitioned into two spaces by the plunger 14. These two spaces are volume variable chambers, in each of which a volume of the chamber varies upon displacement of the plunger 14. One (left side space) of these volume variable chambers, which is defined between the plunger 14 and the opposing magnetic portion 18b, will be referred to as a plunger front chamber B, and the other one (right side space) of these volume variable chambers, which is located on the other side of the plunger 14 that is opposite from the opposing magnetic portion 18b, will be referred to as a plunger rear chamber C.

At the time of axially displacing the plunger 14, the plunger front chamber B and the plunger rear chamber C need to be communicated with an outside communicating portion located at the spool valve 1 side to enable volume change of the plunger front chamber B and volume change of the plunger rear chamber C.

The outside communicating portion at the spool valve 1 side is a space defined between the spool 4 and the solenoid actuator 2 (hereinafter, referred to as a solenoid front chamber A). The solenoid front chamber A is communicated with the outside (a low pressure part or side) through a sleeve breathing hole 7a, which is formed in the sleeve 3.

According to the previously propose technique, as shown in FIG. 4A, in order to communicate the solenoid front chamber A to the plunger front chamber B and the plunger rear chamber C, a shaft breathing groove J1 is formed to extend in the axial direction in an outer peripheral surface of the shaft 11, and a plunger breathing hole 14a is formed to axially extend through the plunger 14 (or a plunger breathing groove that extends in the axial direction in an outer peripheral surface of the plunger 14).

Thus, the oil, which corresponds to a difference between the amount of volume change of the plunger front chamber B and the amount of volume change of the plunger rear chamber C caused by the displacement of the plunger 14, flows inward or outward through the shaft breathing groove J1. That is, the oil, which contains foreign debris, directly flows from the solenoid front chamber A to the plunger front chamber B through the shaft breathing groove 31 upon the displacement of the plunger 14. When the oil, which contains the foreign debris, directly flows into the plunger front chamber B, the foreign debris, which is contained in the oil, may possibly be accumulated in the plunger front chamber B to cause sliding malfunction of the plunger 14 by the foreign debris accumulated in the plunger front chamber B.

The solenoid actuator 2 has a plate 24, which is made of a non-magnetic material and limits contact of the plunger 14 to the opposing magnetic portion 18b of the stator core 21 at the time when the plunger 14 is moved to its full stroke position.

As shown in FIG. 4A, the plate 24 is securely press fitted around the shaft 11. Therefore, the press fitting process for press fitting the plate 24 to the shaft 11 is required to cause an increase in the costs.

Furthermore, as shown in FIG. 4B, in place of the plate 24, it is conceivable to provide an increased diameter portion 32 at the end of the shaft 11 to limit the direct contact between the plunger 14 and the stator core 21. However, a cutting amount for creating the shaft breathing groove 31 is increased due to the increased diameter portion 32 to cause an increase in the costs.

### SUMMARY OF THE INVENTION

The present invention addresses the above disadvantages. According to one aspect of the present invention, there is provided a solenoid valve, which includes a valve device, a solenoid actuator and a shaft. The valve device includes a valve element, which is driven to open or close each corresponding one of a plurality of oil flow passages. The solenoid actuator includes a coil, a plunger and an opposing magnetic portion. The coil generates a magnetic force upon energization of the coil. The plunger is axially slidably supported. The opposing magnetic portion is axially opposed to the plunger and magnetically attracts the plunger toward the valve element through use of the magnetic force generated by the coil. The shaft is placed through an axial through hole of the opposing magnetic portion and applies a displacement force of the plunger to the valve element. The plunger has a plunger breathing hole that axially extends through the plunger along a center axis of the plunger. The shaft has a small diameter pipe portion, which is received in the plunger breathing hole, and a large diameter pipe portion, which has an inner diameter and an outer diameter that are larger than an inner diameter of the plunger breathing hole. A first inside-to-outside communicating portion is formed in a valve device side part of the large diameter pipe portion to communicate between an interior of the large diameter pipe portion and an outside communicating portion, which is formed in the valve device and is communicated with an outside of the valve device. A second inside-to-outside communicating portion is formed in a plunger side part of the large diameter pipe portion to communicate between the interior of the large diameter pipe portion and a plunger front chamber, which is formed between the opposing magnetic portion and the plunger. A third inside-to-outside communicating portion is formed in a distal end part of the small diameter pipe portion on a side opposite from the large diameter pipe portion to communicate between an interior of the small diameter pipe portion and a plunger rear chamber, which is formed on an opposite side of the plunger that is opposite from the opposing magnetic portion.

### BRIEF DESCRIPTION OF THE DRAWINGS

The invention, together with additional objectives, features and advantages thereof, will be best understood from the following description, the appended claims and the accompanying drawings in which:

FIG. 1A is a longitudinal cross sectional view of a solenoid hydraulic pressure control valve according to a first embodiment of the present invention;

FIG. 1B is an enlarged partial view of a portion of FIG. 1A;

FIG. 2A is a longitudinal cross sectional view of a solenoid hydraulic pressure control valve according to a second embodiment of the present invention;

FIG. 2B is an enlarged partial view of a portion of FIG. 2A;

FIG. 3A is a longitudinal cross sectional view of a solenoid hydraulic pressure control valve according to a third embodiment of the present invention;

FIG. 3B is an enlarged partial view of a portion of FIG. 3A;

FIG. 4A is a longitudinal cross sectional view of a previously proposed solenoid hydraulic pressure control valve; and

FIG. 4B is a longitudinal cross sectional view of another previously proposed solenoid hydraulic pressure control valve.

### DETAILED DESCRIPTION OF THE INVENTION

### First Embodiment

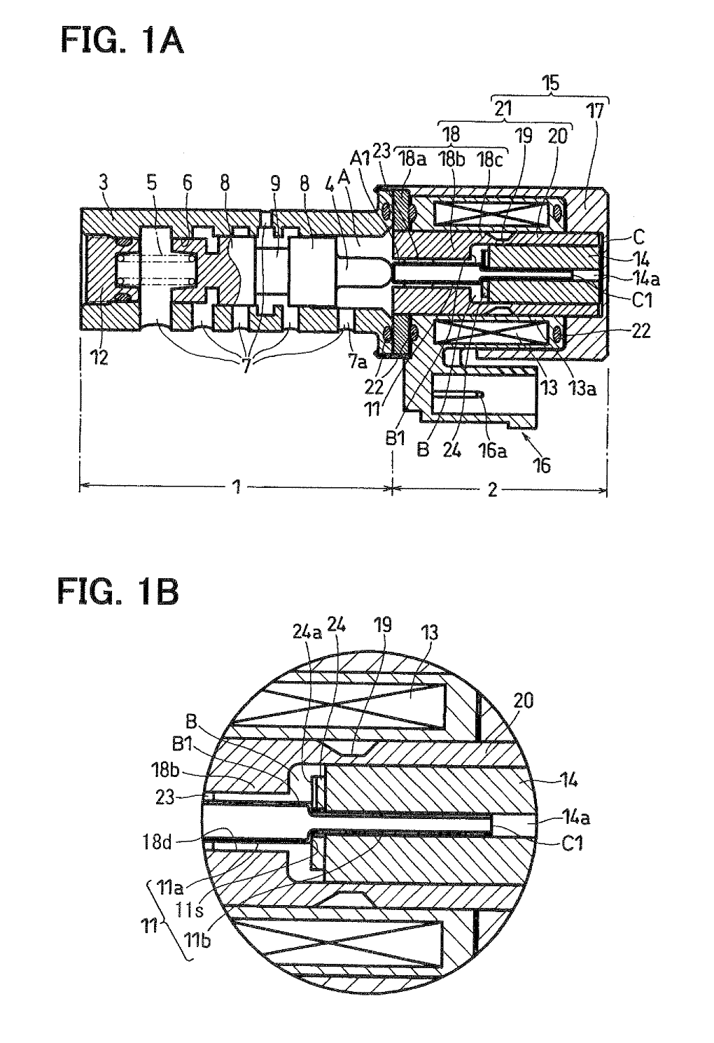

With reference to FIGS. 1A and 1B, a description will be now made to an embodiment, in which the present invention is applied to a solenoid hydraulic pressure control valve that controls a hydraulic pressure of an automatic transmission. In the following description, the left side of FIGS. 1A and 1B will be referred to as a front side, and the right side of FIGS. 1A and 1B will be referred to as a rear side for the illustrative purpose. However, these terms are not related to the actual installation direction.

The solenoid hydraulic pressure control valve of the first embodiment is a solenoid spool valve, which controls the hydraulic pressure and is installed in a hydraulic pressure control device of the automatic transmission. Specifically, the solenoid hydraulic pressure control valve of the first embodiment includes a spool valve 1 and a solenoid actuator 2 (linear solenoid). The spool valve 1 is received in the interior of a hydraulic pressure control case that is fluid tightly sealed from the outside. The spool valve 1 is driven in the hydraulic pressure control case, for example, to open and close the oil flow passages, to switch the oil flow passages, to control pressure in the oil flow passages and to control the amount of flow in the oil flow passages. The solenoid actuator 2 is placed outside of the hydraulic pressure control case and drives the spool valve 1. The solenoid actuator is exposed to the air.

The spool valve 1 includes a sleeve 3, a spool (valve element) 4 and a spring 5 (return spring).

The sleeve 3 is configured into a generally cylindrical body and has a receiving hole 6, which extends along a center axis of the sleeve 3 to axially slidably receive the spool 4 therein. Furthermore radial oil ports 7 are formed in the sleeve 3.

The oil ports 7 include an input port, an output port, a discharge port and drain ports. The input port is communicated with an oil discharge outlet of an oil pump (not shown) and receives an input pressure from the oil pump. The output pressure, which is adjusted by the solenoid hydraulic pressure control valve, is outputted through the outlet port. The discharge port is communicated with the low pressure side. The drain ports are provided to enable breathing through the drain ports.

The drain ports enable the breathing of the interior of the spool valve 1 (inflow/outflow of the oil upon changing of the volume of the interior of the spool valve 1) and the breathing of the interior of the solenoid actuator 2. The drain ports are communicated with the discharge port through the oil passage in the hydraulic pressure control case, and the discharge port is communicated with the low pressure side (an oil pan of the automatic transmission) through the oil passage in the hydraulic pressure control case.

The drain ports, which are provided in the sleeve 3, include a front side drain port and a rear side drain port

The front side drain port of the sleeve 3 communicates between a spring chamber, which receives the spring 5, and the outside of the sleeve 3 (the low pressure side).

The rear side drain port of the sleeve 3 communicates between a solenoid front chamber A and the outside of the sleeve 3 (the low pressure side). The solenoid front chamber A is axially defined between the spool 4 and the solenoid actuator 2 (specifically, an opposing magnetic portion 18b described below). In the following description, the rear side drain port of the sleeve 3, which communicates between the solenoid front chamber A and the outside of the sleeve 3 (the low pressure side), will be referred to as a sleeve breathing hole 7a.

The spool 4 is slidably placed in the sleeve 3 to change the cross sectional area of the opening of each corresponding one of the oil ports 7 (more specifically, to change the cross sectional area of the opening of each of the input port and the discharge port and thereby to change the hydraulic output pressure at the output port) and changes the communication state of the respective oil ports 7 (more specifically, changes the state between the communication state for communicating between the input port and the output port upon closing of the discharge port and the other communication state for communicating between the output port and the discharge port upon closing of the input port). The spool 4 includes a plurality of lands 8 and a small diameter portion 9. The lands 8 are configured such that the lands 8 can close the corresponding oil ports 7 depending on the slide position of the spool 4. The small diameter portion 9 is provided between the lands 8.

A rear end of the spool 4 is in contact with a front end of a shaft 11, which conducts the drive force of the solenoid actuator 2 to the spool 4. Furthermore, a rear end of a large diameter pipe portion 11a of the shaft 11 is in contact with a front end surface of a plunger 14 described latter, so that the plunger 14 axially drives the spool 4.

The spring 5 is a compressive coil spring, which urges the spool 4 toward the solenoid actuator 2. The spring 5 is placed in a compressed state thereof in the spring chamber, which is located at the front side of the sleeve 3. One end of the spring 5 is in contact with a front surface of the spool 4, and the other end of the spring 5 is in contact with a bottom surface of an adjust screw 12, which closes the front end of the receiving hole 6 of the sleeve 3. The urging force of the spring 5 can be adjusted by adjusting an amount thread engagement (an amount of threaded in) of the adjust screw 12.

The solenoid actuator 2 includes the coil 13, the plunger 14, a magnetic stator 15 and a connector 16.

The coil 13 generates a magnetic force upon energization thereof to create a magnetic flux loop, which flows through the plunger 14 and the magnetic stator 15. The coil 13 is formed by winding a wire (enamel wire), which is coated with a dielectric film, around a bobbin 13a made of resin.

The plunger 14 is a generally cylindrical body made of magnetic metal (e.g., a ferromagnetic material, such as iron).

The plunger 14 directly slides along an inner peripheral surface of the magnetic stator 15 (more specifically, along an inner peripheral surface of a stator core 21, discussed latter).

Furthermore, as described above, the plunger 14 has the front end surface that is in contact with the rear end of the large diameter pipe portion 11a of the shaft 11 of the spool 4, so that the plunger 14 and the spool 4 are both urged toward the rear side by the urging force of the spring 5.

The magnetic stator 15 includes a yoke 17 and the stator core 21. The yoke 17 is made of a magnetic material and is configured into a generally cup-shape body, which surrounds the outer peripheral surface of the coil 13. The stator core 21 is made of a magnetic material and includes a magnetically attracting core 18, a magnetically insulating portion 19 and a slidable core 20, which are integrally formed. The stator core 21 is inserted into the yoke 17 through a cup opening (a front side) of the yoke 17, and the sleeve 3 and the stator core 21 are fixed together at the cup opening of the yoke 17.

The yoke 17 is made of magnetic metal (e.g., a ferromagnetic material, such as iron) and surrounds the coil 13 to form a magnetic flux. After installing the components of the solenoid actuator 2 into the yoke 17, the yoke 17 is securely coupled to the sleeve 3 by bending claw portions, which are formed at the end portion (the left end portion in FIG. 1A) of the yoke 17, against the sleeve 3.

The magnetically attracting core 18 is made of magnetic metal (e.g., a ferromagnetic material, such as iron) and includes a flange portion 18a and the opposing magnetic portion 18b. The flange portion 18a is magnetically coupled to the opening end of the yoke 17. The opposing magnetic portion 18b is axially opposed to the plunger 14 and supports the shaft 11 in an axially slidable manner. A magnetically attracting portion (a main magnetic gap) is formed between the opposing magnetic portion 18b and the plunger 14. In the present embodiment, the opposing magnetic portion 18b is securely coupled to the inner peripheral surface of the flange portion 18a by a fixing technique, such as by press-fitting. Alternatively, the flange portion 18a and the opposing magnetic portion 18b may be formed integrally.

A tubular recessed portion 18c, in which an end portion of the plunger 14 can be accommodated, is provided in a portion of the magnetically attracting core 18. The magnetically attracting core 18 and a portion of the plunger 14 axially intersect each other. The outer peripheral surface of the tubular recessed portion 18c is tapered such that the magnetic attractive force does not change in response to the amount of stroke of the plunger 14.

The magnetically insulating portion 19 is a magnetically saturating portion, which limits the direct flow of the magnetic flux between the magnetically attracting core 18 and the slidable core 20. The magnetically insulating portion 19 is made of a thin wall portion, which has a relatively high magnetic resistance.

The slidable core 20 is made of magnetic metal (e.g., a ferromagnetic material, such as iron) and is configured into a cylindrical body, which covers generally the entire outer peripheral surface of the plunger 14. The slidable core 20 is received in a recess, which is formed in a cup bottom portion of the yoke 17 (on the rear side). The slidable core 20 is magnetically coupled to the yoke 17.

The plunger 14 directly slides along the inner peripheral surface of the slidable core 20, and the magnetic flux is radially transmitted between the slidable core 20 and the plunger 14. A magnetic exchange portion (a side magnetic gap) is formed between the slidable core 20 and the plunger 14.

The connector 16 is a connecting means for electrically connecting with an electronic control unit (AT-ECU not shown), which controls the solenoid hydraulic pressure control valve. Terminals 16a, which are connected to two ends, respectively, of the coil 31, are provided in an interior of the connector 16.

In FIG. 1A, numeral 22 indicates a sealing member (e.g., an O-ring) that seals the interior of the solenoid actuator 2, which is covered with the yoke 17, from the outside to limit leakage of the oil into the surrounding space where the solenoid actuator 2 is exposed.

The shaft 11 is placed in an axial through hole 18d, which extends through the opposing magnetic portion 18b along a center axis of the opposing magnetic portion 18b, in such a manner that the shaft 11 is axially slidably supported by a thrust bearing 23 held by the inner peripheral surface of the axial through hole 18d. The shaft 11 is installed such that the shaft 11 is held between the spool 4 and the plunger 14. Furthermore, as discussed above, the shaft 11 conducts the drive force of the plunger 14 to the spool 4 and also conducts the urging force of the spring 5 from the spool 4 to the plunger 14.

The shaft 11 of the first embodiment is a hollow component, which is produced by processing a non-magnetic thin plate (e.g. a stainless plate) into a double step pipe form, so that the shaft 11 includes the large diameter pipe portion 11a and a small diameter pipe portion 11b. The large diameter pipe portion 11a is placed in a center portion of the opposing magnetic portion 18b. The small diameter pipe portion 11b has an outer diameter smaller than that of the large diameter pipe portion 11a. The front end of the shaft 11 (the contacting portion that contacts with the spool 4) is closed by the metal plate, which forms the shaft 11.

As described above, the interior of the shaft 11 is hollow, and this hollow interior of the shaft 11 forms a shaft interior breathing passage.

A first inside-to-outside communicating portion A1 is formed in the spool valve 1 side (the front side) part of the large diameter pipe portion 11a to communicate between the interior of the large diameter pipe portion 11a and the solenoid front chamber A (an example of an outside communicating portion), which is communicated with the outside (the low pressure side) through the sleeve breathing hole 7a.

The first inside-to-outside communicating portion A1 is a radial through hole, which radially extends through a peripheral wall of the shaft 11 and is provided at the front side part of the large diameter pipe portion 11a (i.e., the portion of the large diameter pipe portion 11a, which is located on the front side of the front end of the thrust bearing 23 even when the plunger 14 is placed in an initial position upon stopping of the electric power supply to the coil 13), and thereby the first inside-to-outside communicating portion A1 is always communicated with the solenoid front chamber A throughout the entire moving range of the shaft 11.

A second inside-to-outside communicating portion B1 is formed in the plunger 14 side (the rear side) part of the large diameter pipe portion 11a to communicate between a plunger front chamber B and the interior of the large diameter pipe portion 11a. The plunger front chamber B is formed between the opposing magnetic portion 18b and the plunger 14.

Similar to the first inside-to-outside communicating portion A1, the second inside-to-outside communicating portion B1 is a radial through hole, which radially extends through the peripheral wall of the shaft 11 and is provided at the rear side part of the large diameter pipe portion 11a (i.e., the part of the large diameter pipe portion 11a, which is located on the rear side of the rear end of the thrust bearing 23 even when the plunger 14 is placed in a full stroke position upon providing of the maximum electric power supply to the coil 13), and thereby the second inside-to-outside communicating portion B1 is always communicated with the plunger front chamber B throughout the entire moving range of the shaft 11.

The number of the first inside-to-outside communicating portion(s) A1 may be one or more. Also, the number of the second inside-to-outside communicating portion(s) B1 may be one or more. Here, it is desirable that the inside-to-outside communicating holes, which form the first and second inside-to-outside communicating holes A1, B1, should be directed only to the upward direction (i.e., should be directed toward the vertically upward direction) upon installation of the solenoid hydraulic pressure control valve on the vehicle (in the practically installed state). Specifically, when the first and second inside-to-outside communicating holes A1, B1 are provided at the one radial side of the large diameter pipe portion 11a, the weight of the one radial side of the large diameter pipe portion 11a is reduced in comparison to the other radial side of the large diameter pipe portion 11a. Thereby, the first and second inside-to-outside communicating holes A1, B1 can be directed in the upward direction.

Here, a plunger breathing hole 14a extends through the plunger 14 in the axial direction. A rear end of the plunger breathing hole 14a is always communicated with a plunger rear chamber C, which is axially formed between the plunger 14 and the cup bottom portion of the yoke 17. The plunger breathing hole 14a of the present embodiment axially extends through the plunger 14 along the center axis of the plunger 14.

The small diameter pipe portion 11b is received in the interior of the plunger breathing hole 14a. An outer diameter of the small diameter pipe portion 11b is set such that the small diameter pipe portion 11b is lightly press fitted to the inner peripheral surface of the plunger breathing hole 14a or is alternatively set such that the small diameter pipe portion 11b is received in the interior of the plunger breathing hole 14a with an installation clearance provided between the small diameter pipe portion 11b and the inner peripheral surface of the plunger breathing hole 14a.

A third inside-to-outside communicating portion C1 is provided at the rear end of the small diameter pipe portion 11b to communicate between the plunger rear chamber C and the interior of the small diameter pipe portion 11b. The third inside-to-outside communicating portion C1 is a pipe opening at the distal end of the small diameter pipe portion 11b and is opened in the interior of the plunger breathing hole 14a.

As described above, the plunger front chamber B and the plunger rear chamber C of the first embodiment are communicated only to the interior of the large diameter pipe portion 11a through the second and third inside-to-outside communicating portions B1, C1, respectively, and the interior of the large diameter pipe portion 11a is communicated with the outside (the low pressure side) through the first inside-to-outside communicating portion A1, the solenoid front chamber A and the sleeve breathing hole 7a.

Thus, the volume change (breathing) of the plunger front chamber B and the volume change (breathing) of the plunger rear chamber C upon the movement of the plunger 14 are made possibly only through the interior of the large diameter pipe portion 11a.

In the first embodiment, the interior volume of the large diameter pipe portion 11a is set to be equal to or larger than a difference between the amount of volume change of the plunger front chamber B and the amount of volume change of the plunger rear chamber C. Unlike the first embodiment, the interior volume of the large diameter pipe portion 11a may be set to be smaller than the difference between the amount of volume change of the plunger front chamber B and the amount of volume change of the plunger rear chamber C.

When the plunger 14 is moved upon the controlling of the electric power supply of the coil 13 of the solenoid actuator 2, the volume of the plunger front chamber B and the volume of the plunger rear chamber C are changed, and thereby the oil flow (oil inflow or outflow) is created between the interior of the large diameter pipe portion 11a and each of the plunger front chamber B and the plunger rear chamber C.

Also, the oil flow (oil inflow or outflow) is created between the spool valve 1 side (the solenoid front chamber A) and the interior of the large diameter pipe portion 11a through the first inside-to-outside communicating portion A1 for the amount, which corresponds to the difference between the amount of volume change of the plunger front chamber B and the amount of volume change of the plunger rear chamber C.

Here, the oil, which is drawn from the solenoid front chamber A to the solenoid actuator 2 side, is supplied to the interior of the shaft 11 through the first inside-to-outside communicating portion A1. The shaft 11 has the stepped structure, which is created by the large diameter pipe portion 11a and the small diameter pipe portion 11b. Therefore, the foreign debris, which is contained in the oil, tends to be accumulated in the interior of the large diameter pipe portion 11a. Therefore, the foreign debris, which is contained in the oil drawn from the solenoid front chamber A to the solenoid actuator 2 side, is accumulated in the interior of the large diameter pipe portion 11a and is thereby not substantially conducted to the plunger front chamber B and the plunger rear chamber C.

As a result, it is possible to limit the sliding malfunction of the plunger sliding portion for a relatively long period, and thereby it is possible to improve the reliability of the solenoid hydraulic pressure control valve.

The oil flow (oil inflow or outflow) is created between the interior (serving as a volume chamber) of the large diameter pipe portion 11a and each of the plunger front chamber B and the plunger rear chamber C. Thus, it is possible to limit the amount of oil, which is newly drawn from the solenoid front chamber A into the plunger front chamber B and the plunger rear chamber C.

Particularly, in the first embodiment, the volume of the interior of the large diameter pipe portion 11a is set to be equal to or larger than the difference between the amount of volume change of the plunger front chamber B and the amount of volume change of the plunger rear chamber C (i.e., the amount of oil that passes through the first inside-to-outside communicating portion A1 due to the breathing), so that the oil, which flows into or out of each of the plunger front chamber B and the plunger rear chamber C, is substantially retained in the interior of the large diameter pipe portion 11a. Thereby, it is possible to minimize the amount oil, which is drawn from the solenoid front chamber A into the plunger front chamber B and the plunger rear chamber C. As a result, it is possible to reduce the possibility of intrusion of the foreign debris into the plunger front chamber B and the plunger rear chamber C, and thereby it is possible to improve the reliability of the solenoid hydraulic pressure control valve.

Also, in the present embodiment, as discussed above, the first inside-to-outside communicating portion A1 radially extends through the peripheral wall of the large diameter pipe portion 11a, so that the sleeve breathing hole 7a is not likely communicated to the first inside-to-outside communicating portion A1 along a linear line, and thereby the solenoid front chamber A can be used as a simple labyrinth or maze. As a result, it is possible to reduce the possibility of conducting the foreign debris into the first inside-to-outside communicating portion A1, and thereby it is possible to improve the reliability of the solenoid hydraulic pressure control valve.

Particularly, the inside-to-outside through hole, which forms the first inside-to-outside communicating portion A1, is directed only to the upward direction upon the installation on the vehicle (in the practically installed state), so that it is possible to reduce the possibility of the foreign debris (cutting debris or abrasion debris), which tends to precipitate by the gravitational force, from reaching the first inside-to-outside communicating portion A1. Thereby, it is possible to improve the reliability of the solenoid hydraulic pressure control valve.

Furthermore, the inside-to-outside through hole, which forms the second inside-to-outside communicating portion B1, is directed only to the upward direction upon the installation on the vehicle (in the practically installed state), so that it is possible to avoid occurrence of discharging of the foreign debris, which is precipitated in the bottom of the interior of the large diameter pipe portion 11a, toward the outside of the large diameter pipe portion 11a (toward the plunger front chamber B). Thereby, it is possible to improve the reliability of the solenoid hydraulic pressure control valve.

A plate 24, which is made of a non-magnetic material, is used in the solenoid actuator 2 of the first embodiment to limit contact of the plunger 14 to the opposing magnetic portion 18b at the time when the plunger 14 is moved to its full stroke position.

The plate 24 is supported and held between the plunger 14 and a step surface 11s, which is formed in the step between the large diameter pipe portion 11a and the small diameter pipe portion 11b.

Specifically, the plate 24 is made of the non-magnetic metal (e.g., brass, copper, stainless steel) or hard resin and is configured into an annular plate (ring). A center hole of the plate 24 is a receiving hole, which receives the small diameter pipe portion 11b. An inner diameter of the center hole of the plate 24 is set to be larger than an outer diameter of the small diameter pipe portion 11b.

As described above, the plate 24 can be fixed by simply clamping the plate 24 between the step surface 11s of the shaft 11 and the plunger 14. Therefore, the manufacturing costs can be reduced in comparison to previously proposed techniques (such as a technique of press fitting the plate 24 to the shaft 11, a technique of providing an enlarged diameter portion at the end of the shaft 11 and creating a shaft breathing groove by cutting).

In the first embodiment, the plate 24 is made of the non-magnetic material. However, since the plate 24 is provided for the purpose of limiting the magnetic coupling between the plunger 14 and the opposing magnetic portion 18b, it is possible to form the plate 24 from a magnetic material as long as it can limit the magnetic coupling between the plunger 14 and the opposing magnetic portion 18b.

Specifically, for example, the plate 24 may be formed by the magnetic metal (e.g., the iron). Furthermore, as shown in FIG. 1B, a protrusion 24a may be locally provided to a portion of the front surface of the plate 24, which is axially opposed to the opposing magnetic portion 18b, to increase the magnetic resistance at the time of making the contact with the opposing magnetic portion 18b and therefore to cause the magnetic saturation, thereby limiting the magnetic coupling between the plunger 14 and the opposing magnetic portion 18b. The protrusion 24a may be configured as a streak protrusion(s) or a circular protrusion(s). When the plate 24 is made of the inexpensive metal (e.g., iron), the material costs can be limited.

### Second Embodiment

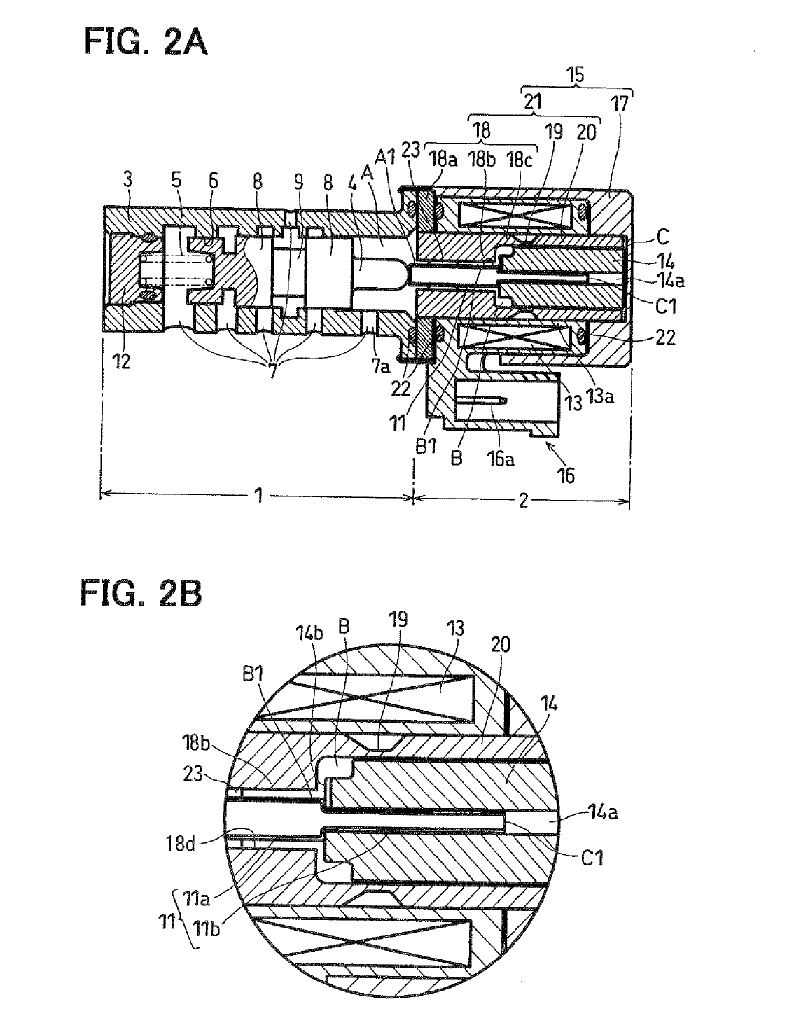

A second embodiment of the present invention will be described with reference to FIGS. 2A and 2B. In the following description of the embodiments, components, which are similar to those of the first embodiment, will be indicated by the same reference numerals.

In the first embodiment, the plate 24, which is formed as the separate component, is clamped between the plunger 14 and the step surface 11s, which is formed in the step between the large diameter pipe portion 11a and the small diameter pipe portion 11b.

In the second embodiment, the plate 24 of the first embodiment is eliminated, and a center portion of the front surface of the plunger 14 is bulged toward the front side. Furthermore, a local protrusion 14b is formed in the front end surface of the bulged center portion provided at the front surface of the plunger 14. The protrusion 14b directly contacts the opposing magnetic portion 18b when the plunger 14 is moved to its full stroke position. The protrusion 14b may be configured as a streak protrusion(s) (e.g., a crisscross shaped protrusion having a crisscross shape in an axial view thereof) or may be a circular protrusion(s).

According to the second embodiment, even when the plunger 14 directly contacts the opposing magnetic portion 18b, only a distal end of the local protrusion 14b provided at the front surface of the plunger 14 contacts the opposing magnetic portion 18b. As a result, the magnetic resistance of the contacting portion is increased to cause the magnetic saturation, and thereby it is possible to limit the magnetic coupling between the plunger 14 and the opposing magnetic portion 18b.

In this way, the installation of the plate 24 is no longer required, and the number of components can be reduced to limit the manufacturing costs.

### Third Embodiment

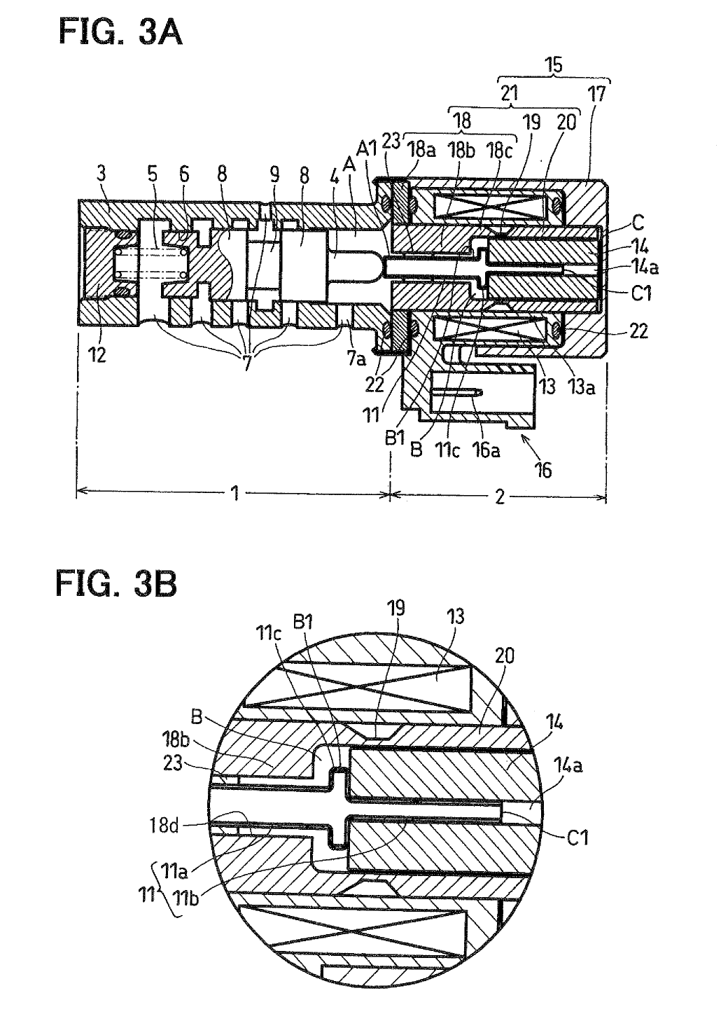

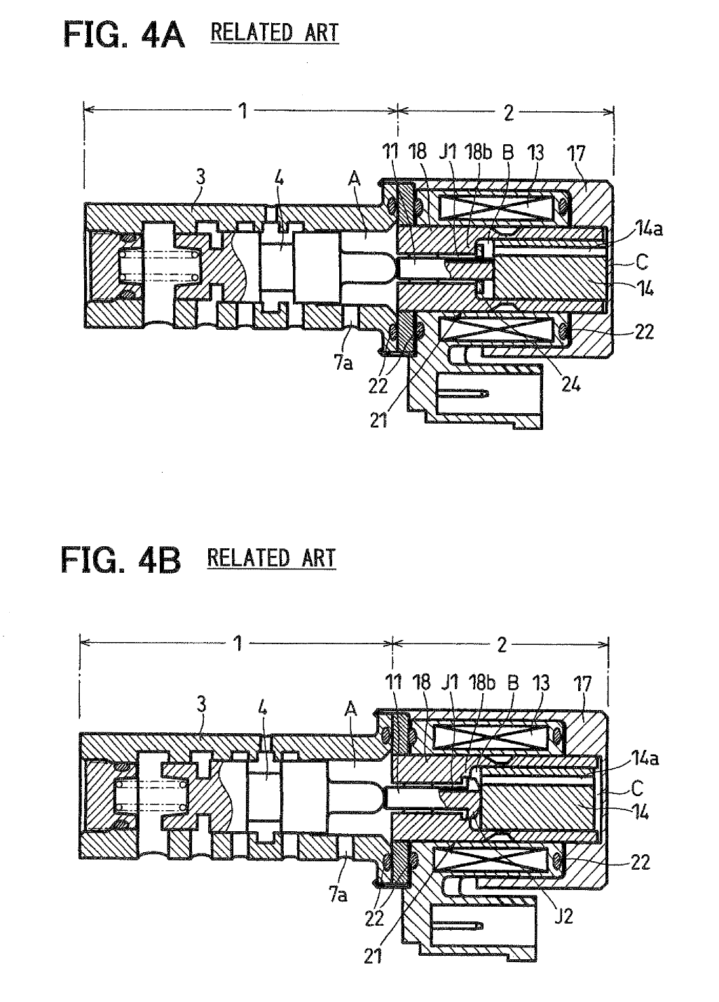

A third embodiment of the present invention will be described with reference to FIGS. 3A and 3B.

In the second embodiment, the plate 24 is eliminated by providing the protrusion 14b in the plunger 14.

In the third embodiment, the plate 24 is eliminated, and the function of the plate 24 is implemented in a portion of the hollow shaft 11 made of the non-magnetic material.

Specifically, in the third embodiment, an increased diameter bent portion (a flange portion) 11c is formed at the plunger 14 side end (rear end) part of the large diameter pipe portion 11a. The increased diameter bent portion 11c has an outer diameter, which is larger than an inner diameter of the axial through hole 18d that extends through the opposing magnetic portion 18b along the center axis of the opposing magnetic portion 18b. In other words, the outer diameter of the increased diameter bent portion 11c is larger than the outer diameter of the rest of the large diameter pipe portion 11a. When the increased diameter bent portion 11c is clamped between the opposing magnetic portion 18b and the plunger 14, the direct contact between the opposing magnetic portion 18b and the plunger 14 is limited.

In this way, similar to the second embodiment, the installation of the plate 24 is no longer required, and the number of components can be reduced to limit the manufacturing costs.

In the above embodiments, the present invention is applied to the solenoid hydraulic pressure control valve used in the hydraulic pressure control device of the automatic transmission. Alternatively, the present invention may be applied to a solenoid hydraulic pressure control valve of any other device, which is other than the automatic transmission. Furthermore, the present invention may be applied to a solenoid valve(s) other than the solenoid hydraulic pressure control valve(s).

In the above embodiments, the spool valve 1 is illustrated as the example of the valve device. However, the valve device is not limited to the spool valve 1. That is, the valve device of the present invention may be any other type of valve device, in which a valve element is driven through the shaft 11.

In the above embodiments, the magnetically attracting core 18 and the slidable core 20 are formed integrally. Alternatively, the magnetically attracting core 18 and the slidable core 20 may be formed separately.

Additional advantages and modifications will readily occur to those skilled in the art. The invention in its broader terms is therefore not limited to the specific details, representative apparatus, and illustrative examples shown and described.

What is claimed is:

1. A solenoid valve comprising:
a valve device that includes a valve element, which is driven to open or close each corresponding one of a plurality of oil flow passages;
a solenoid actuator that includes:
a coil that generates a magnetic force upon energization of the coil;
a plunger that is axially slidably supported; and
an opposing magnetic portion that is axially opposed to the plunger and magnetically attracts the plunger toward the valve element through use of the magnetic force generated by the coil; and
a shaft that is placed through an axial through hole of the opposing magnetic portion and applies a displacement force of the plunger to the valve element, wherein:
the plunger has a plunger breathing hole that axially extends through the plunger along a center axis of the plunger;
the shaft has a small diameter pipe portion, which is received in the plunger breathing hole, and a large diameter pipe portion, which has an inner diameter and an outer diameter that are larger than an inner diameter of the plunger breathing hole;
a first inside-to-outside communicating portion is formed in a valve device side part of the large diameter pipe portion to communicate between an interior of the large diameter pipe portion and an outside communicating portion, which is formed in the valve device and is communicated with an outside of the valve device;
a second inside-to-outside communicating portion is formed in a plunger side part of the large diameter pipe portion to communicate between the interior of the large diameter pipe portion and a plunger front chamber, which is formed between the opposing magnetic portion and the plunger; and
a third inside-to-outside communicating portion is formed in a distal end part of the small diameter pipe portion on a side opposite from the large diameter pipe portion to communicate between an interior of the small diameter pipe portion and a plunger rear chamber; which is formed on an opposite side of the plunger that is opposite from the opposing magnetic portion.

2. The solenoid valve according to claim 1, wherein the first inside-to-outside communicating portion radially extends through a peripheral wall of the large diameter pipe portion.

3. The solenoid valve according to claim 1, wherein a volume of the interior of the large diameter pipe portion is equal to or larger than a difference between an amount of volume change of the plunger front chamber and an amount of volume change of the plunger rear chamber.

4. The solenoid valve according to claim 1, wherein:
a plate, which is made of a non-magnetic material, is clamped between the plunger and a step surface of the shaft, which is formed in a step between the large diameter pipe portion and the small diameter pipe portion; and
the plate limits direct contact between the opposing magnetic portion and the plunger upon movement of the plunger toward the opposing magnetic portion.

5. The solenoid valve according to claim 1, wherein:
a protrusion is formed in an axial end surface of the plunger; and
the protrusion of the plunger directly contacts the opposing magnetic portion upon movement of the plunger toward the opposing magnetic portion.

6. The solenoid valve according to claim 1, wherein:
an increased diameter bent portion is formed in a plunger side part of the large diameter pipe portion and has an outer diameter that is increased from the rest of the large diameter pipe portion; and
the increased diameter bent portion is clamped between the opposing magnetic portion and the plunger to limit direct contact between the opposing magnetic portion and the plunger upon movement of the plunger toward the opposing magnetic portion.
